(19) United States
(12) Patent Application Publication
(10) Pub. No.: US 2011/0158451 A1
(43) Pub. Date: Jun. 30, 2011

(54) Close-Talking Capacitor Microphone

(76) Inventor: Hiroshi Akino, Tokyo (JP)

(21) Appl. No.: 12/965,114

(22) Filed: Dec. 10, 2010

(30) Foreign Application Priority Data
Dec. 25, 2009 (JP) 2009-294959

(51) Int. Cl. H04R 11/04

(52) U.S. Cl. 381/355; 381/174

(57) ABSTRACT

A close-talking capacitor microphone includes: a capacitor microphone unit including a diaphragm, a diaphragm holder to which the diaphragm is attached, a fixed electrode, a printed circuit board, an insulating base on the rear side of the fixed electrode, and a unit casing; a microphone casing fixing the capacitor microphone unit therein and provided with a sound-wave guidance hole; and a shielded wire through which a sound signal is communicated. The unit casing has an opening on a peripheral side surface at a portion between the front side of the printed circuit board and the rear side of the fixed electrode with regard to the height direction. The unit casing has a space that communicates the opening to the printed circuit board. The shielded wire is inserted through the opening on the peripheral side surface of the unit casing to be connected to the printed circuit board.

### BACKGROUND OF THE INVENTION

1. Field of the Invention

The present invention relates to a close-talking capacitor microphone and more specifically, to a structure for preventing an occurrence of noise by protecting a capacitor microphone unit installed in a close-talking capacitor microphone from external electro-magnetic waves.

2. Description of the Related Art

A headset including a microphone and a matched pair of speakers is used for announcement of play-by-play coverage of sports events and as a so-called vocal microphone for musical performances. A conventional headset 19 illustrated in FIG. 5 includes ear speakers 17 that contact respective ears of a user, a headband 18, a flexible pipe 2, and a close-talking capacitor microphone 16 provided at an end of the (gooseneck) flexible pipe 2. The headset 19 has such a structure that the flexible pipe 2 extends to a position around the mouth of the user from one of the ear speakers 17 that forms a general headphone together with the other ear speaker 17 and the headband 18. The close-talking capacitor microphone 16 used in such a headset 19 mainly includes a unidirectional capacitor microphone unit such as that disclosed in Japanese Patent Application Publication 2008-72583.

FIG. 6 illustrates an example of the close-talking capacitor microphone 16 used in a conventional headset. The close-talking capacitor microphone 16 mainly includes a unidirectional capacitor microphone unit 15, a microphone casing 12 incorporating the unidirectional capacitor microphone unit 15, a shielded wire 14 through which a sound signal and the like are communicated to the external of the microphone, and the flexible pipe 2 that protects the shielded wire 14.

In FIG. 6, the unidirectional capacitor microphone 15 incorporated in the microphone casing 12 includes a diaphragm 11, a diaphragm holder 5, a fixed electrode 6, a spacer (not illustrated) that is provided between the diaphragm 11 and the fixed electrode 6, a printed circuit board 10, an insulating base 7 disposed on the rear side (lower side as viewed in FIG. 6) of the fixed electrode 6, and a unit casing 3 that is provided with a sound-wave guidance hole on the front side (upper side as viewed in FIG. 6) and the printed circuit board 10 on the rear side (lower side as viewed in FIG. 6). The elements in the unit casing 3 are positioned by the fixed electrode 6 and the insulating base 7 made of an insulating material. The insulating base 7 is provided with an acoustic terminal hole 8 that is communicated to the external of the unit casing 3 from the rear side of the fixed electrode 6.

A folded portion formed at an opening end of the unit casing 3 pushes the rear surface of the printed circuit board 10, which is disposed on the rear side (lower side as viewed in FIG. 6) of the insulating base 7. Thus, the elements in the unit casing 3 are positioned and fixed therein. A field-effect transistor (FET) 9 that forms an impedance converter is disposed on the front side (upper side as viewed in FIG. 6) of the printed circuit board 10. The FET 9 is electrically connected to the fixed electrode 6 with a terminal of the FET 9 contacting a contact 4 extending from the fixed electrode 6.

The shielded wire 14 is covered by the flexible pipe 2, which is communicated with the microphone casing 12. In FIG. 6, the shielded wire 14 is routed downward along a peripheral surface of the unit casing 3 to be connected to a certain wiring pattern on the rear surface of the printed circuit board 10. The shielded wire 14 is formed of a shield covered wire and includes three lines of a signal line, a power line, and a shielded line. The microphone casing 12 has a cylindrical shape with the front side (upper side as viewed in FIG. 6) and the rear side (lower side as viewed in FIG. 6) opened. The front and rear sides of the microphone casing 12 are covered with respective protecting members 13. The protecting members 13 are each made of, for example, a mesh material and have a sound-wave guidance hole.

As described above, the shielded wire 14 is connected to the unidirectional capacitor microphone unit 15 at a soldering land formed on the rear surface of the printed circuit board 10 disposed on the rear side of the unidirectional capacitor microphone unit 15. Thus, the connection portion is exposed to the external of the unit casing 3. Noise is produced when strong electro-magnetic waves are applied to the exposed portion. As illustrated in FIG. 5, the rear surface of the close-talking capacitor microphone 16 has to be tilted with respect to the horizontal plane so that the sound pickup axis thereof is directed towards the mouth of the user. Therefore, electro-magnetic waves are likely to enter the capacitor microphone unit inside the close-talking capacitor microphone 16 through the rear side, which is the direction opposite from the mouth of the envisioned user. However, no special consideration is given for such a situation. The shielded wire 14, which is used to prevent the occurrence of such noise, is soldered to be in electrical connection with the printed circuit board 10. Therefore, electro-magnetic waves are likely to intrude the signal and the power lines of the shielded wire 14. Furthermore, the shielded wire 14 needs to be routed along the peripheral surface of the unit casing 3. This makes the assembly of the close-talking capacitor microphone 16 difficult. In addition, breakage of the shielded wire 14 may occur because the shielded wire 14 is bent at right angle at multiple portions for the routing.

### SUMMARY OF THE INVENTION

An object of the present invention is to provide a close-talking capacitor microphone that has an innovative structure in which the connected portion between a capacitor microphone unit and a shielded wire is not exposed to prevent the occurrence of noise caused by the entrance of external electro-magnetic waves from the rear surface in the direction opposite from the mouth of an envisioned user due to the rear surface of the close-talking capacitor microphone being tilted with respect to the horizontal plane in the used state, can be easily assembled, and allows the shielded wire to be less bent to prevent the breakage of the shielded wire.

A close-talking capacitor microphone according to an aspect of the present invention includes: a capacitor microphone unit including a diaphragm, a diaphragm holder to which the diaphragm is attached, a fixed electrode arranged opposite to the diaphragm with a space therebetween and forming a capacitor with the diaphragm, a printed circuit board on which an impedance converter is disposed, an insulator provided on the rear side of the fixed electrode, and a unit casing that incorporates the above listed elements and is provided with a sound-wave guidance hole on the front side and the printed circuit board on the rear side; a microphone casing that fixes the capacitor microphone unit therein and is provided with a sound-wave guidance hole on the front side and the rear side of the unit casing; and a shielded wire through which a sound signal is communicated. The unit casing is provided with an opening on a peripheral side surface at a portion between the front side of the printed circuit board and the rear side of the fixed electrode with regard to the height direction. The unit casing is provided with a space that communicates the opening to the front surface of the printed circuit board. The shielded wire is inserted through the opening on the side surface of the unit casing to be connected to the printed circuit board.

According to the aspect of the present invention, the opening is formed on the side surface of the unit casing and the unit casing includes the space that communicates the portion at which the opening is provided to the printed circuit board. The shielded wire is inserted through opening to be connected to a certain pattern formed on the front surface of the printed circuit board. Thus, the connected portion between the capacitor microphone unit and the shielded wire is not exposed. This prevents occurrence of noise caused by external electro-magnetic waves entering from the rear surface in the direction opposite to the mouth of an envisioned user due to the rear surface of the close-talking capacitor microphone being tilted with respect to the horizontal plane in the used state. In addition, the shielded wire can be connected to the printed circuit board without being bent at a large angle. Thus, assembly is easy and the breakage of the shielded wire can be prevented.

### BRIEF DESCRIPTION OF THE DRAWINGS

FIG. 1 is a cross-sectional view of an embodiment of a close-talking capacitor microphone according to the present invention;

FIG. 2 is a front view of an embodiment of a unidirectional capacitor microphone unit in the close-talking capacitor microphone according to the present invention;

FIG. 3 is a side view of the embodiment of the unidirectional capacitor microphone unit;

FIG. 4 is a rear view of the embodiment of the unidirectional capacitor microphone unit;

FIG. 5 is a front view of a conventional headset; and

FIG. 6 is a cross-sectional view of an example of a conventional close-talking capacitor microphone.

### DETAILED DESCRIPTION OF THE PREFERRED EMBODIMENTS

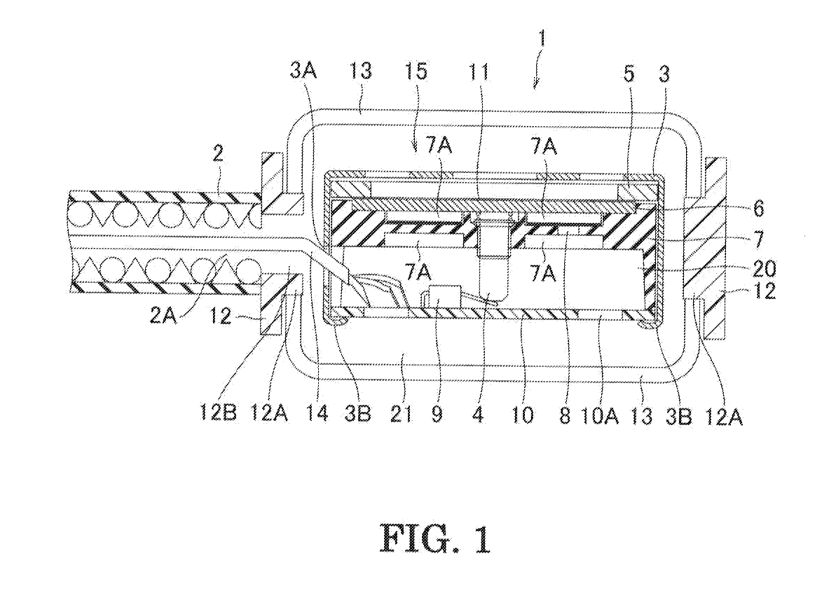

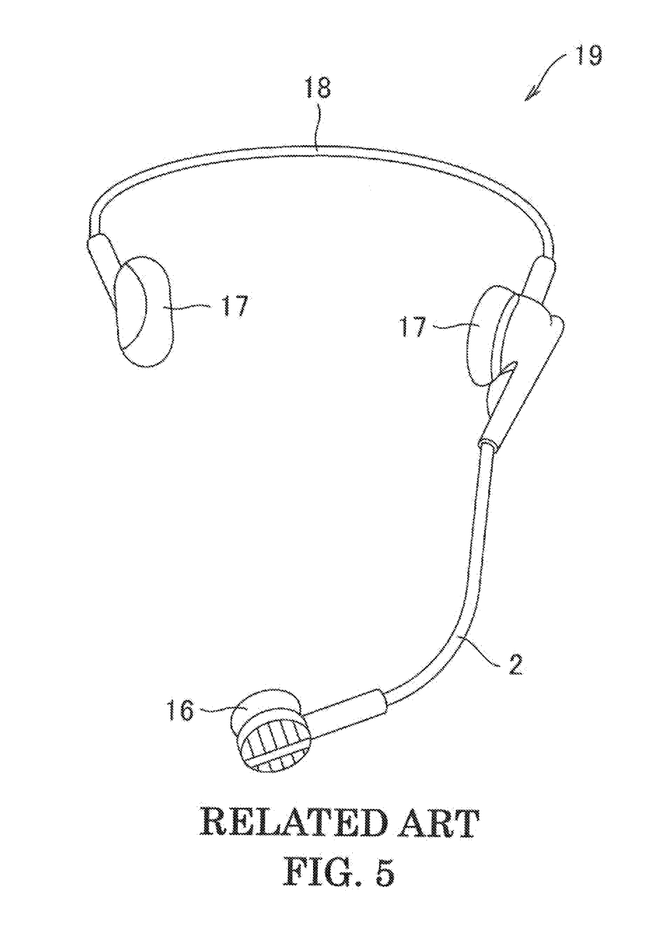

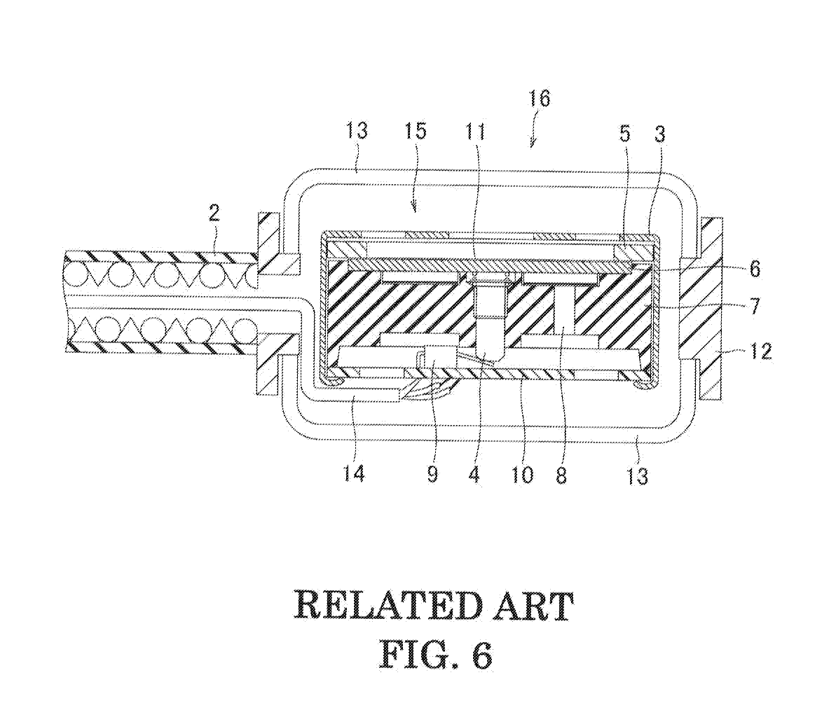

An embodiment of a close-talking capacitor microphone according to the present invention is described with reference to some of the drawings. A close-talking capacitor microphone 1 according to the present invention is assumed to be a part of a headset like the conventional close-talking capacitor microphone 16 illustrated in FIG. 5. More specifically, the close-talking capacitor microphone 1 illustrated in FIG. 1 is supposed to be attached to an end of the (gooseneck) flexible pipe 2 extending to the mouth of the user from a general headphone including the ear speakers 17 that contact the respective ears of the user and the headband 18 in FIG. 5. Still, the structure of the close-talking capacitor microphone 1 according to the present invention is not limited to that of this embodiment. The elements illustrated in FIGS. 1 to 4 similar to those in FIGS. 5 and 6 are given the same reference numerals.

In FIG. 1, the close-talking capacitor microphone 1 according to the present invention mainly includes a unidirectional capacitor microphone unit 15, a microphone casing 12 incorporating the unidirectional capacitor microphone unit 15, a shielded wire 14 through which a sound signal and the like are communicated to the external of the microphone, and a flexible pipe 2 that protects the shielded wire 14 like the conventional counterpart illustrated in FIG. 6.

The unidirectional capacitor microphone unit 15 is incorporated in the microphone casing 12 having a cylindrical shape with its central axis direction aligned with that of the microphone casing 12. Both ends of the microphone casing 12 in the central axis direction (vertical direction as viewed in FIG. 1) are opened. The opened surfaces at both ends in the central axis direction are covered with the respective protecting members 13. The protecting members 13 are formed of, for example, a mesh material, have a sound-wave guidance hole, and have a dish-like shape. The flexible pipe 2 is connected to an outer wall of the microphone casing 12 with a center hole 2A of the flexible pipe 2 communicating with a′hole 12B penetrating the outer wall of the microphone casing 12. The shielded wire 14 passes through the holes thus communicated. The microphone casing 12 has shape in which the inner side on each end in the central axis direction is cut in the thickness direction. Thus, protrusion 12A is formed at the middle portion of the microphone casing 12 in the central axis direction, the protrusion 12A protruding toward the inner direction. The protecting members 13 at the end portions are each fitted to the inner periphery at an end portion of the microphone casing 12 in the central axis direction. The protecting members 13 are each in contact with the protrusion 12A. Thus, the protecting members 13 and the microphone casing 12 are in contact with each other in a fixed manner. The shape and the structure of the microphone casing 12 are not limited to those described above and the microphone casing 12 can have any appropriate forms.

The unidirectional capacitor microphone unit 15 includes a diaphragm 11 formed of a thin film having a disc shape, a diaphragm holder 5 having a ring shape to which the circumferential portion of the diaphragm 11 is attached, a fixed electrode 6 that has a disc shape and is arranged opposite to the diaphragm 11 with a certain space therebetween defined by a spacer provided therebetween to form a capacitor with the diaphragm 11, a printed circuit board 10 having a disc shape on which an impedance converter is disposed, an insulating base 7 that is made of an insulator and is provided on the rear side (lower side as viewed in FIG. 1) of the fixed electrode 6, and a unit casing 3 that incorporates the above listed elements and is provided with sound-wave guidance holes on the front side (upper side as viewed in FIG. 1) and the printed circuit board 10 on the rear side (lower side as viewed in FIG. 1). The capacitor microphone unit used in the close-talking capacitor microphone 1 is not limited to the unidirectional microphone unit and can be of any appropriate type. For example, an omnidirectional microphone unit may be used that has the acoustic terminal hole 8 blocked. The unit casing 3 may have any appropriate shape. Specifically, the shape may or may not be cylindrical as in the embodiment illustrated in FIG. 1 and can also be, for example, a polygonal shape.

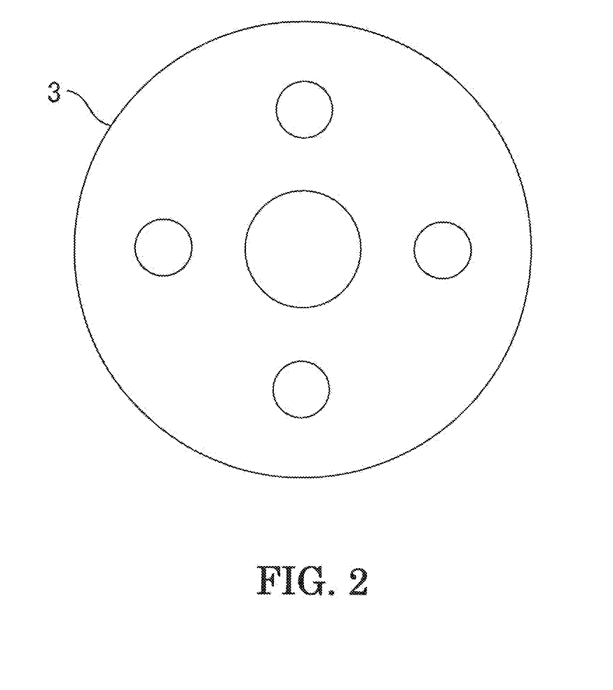

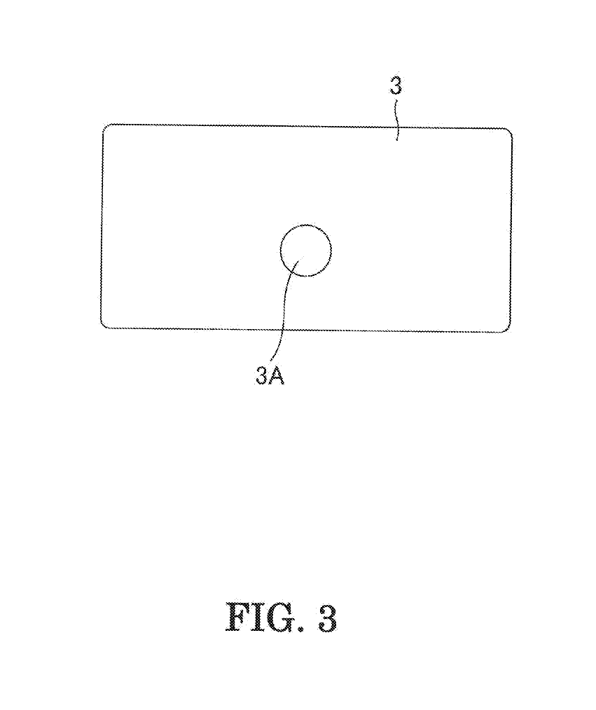

As illustrated in FIG. 2, the front surface of the unit casing 3 is provided with a center hole of a circular shape and four holes being formed at positions provided on the outer side in the radial direction of the center hole. The center hole and the four holes serve as sound-wave guidance holes. In addition, a peripheral side surface of the unit casing 3 is provided with an opening 3A penetrating the peripheral side surface as illustrated in FIG. 3. The opening 3A is provided at the portion of the unit casing 3 that is between the front side (upper side as viewed in FIG. 1) of the printed circuit board 10 and the rear side (lower side as viewed in FIG. 1) of the fixed electrode 6 with regard to the height direction (vertical direction as viewed in FIG. 1) of the unit casing 3. The sound-wave guidance holes of the unit casing 3 are not limited to that described above and the number and the shape of the sound-wave guidance hole can be appropriately set. The unidirectional capacitor microphone unit 15 of this embodiment is different from the conventional counterpart in FIG. 6 in that a space that communicates the position of the hole 3A to the printed circuit board 10 is provided. The shielded wire 14 is inserted through the center hole of the flexible pipe 2 and the opening 3A that is in communication with the central hole and is provided on the side portion of the unit casing 3. The shielded wire 14 is formed of a shield covered wire and includes three lines of a signal line, a power line, and a shielded line. The three lines of the shielded wire 14 are connected to the certain wiring pattern formed on the front side (upper side as viewed in FIG. 1) of the printed circuit board 10.

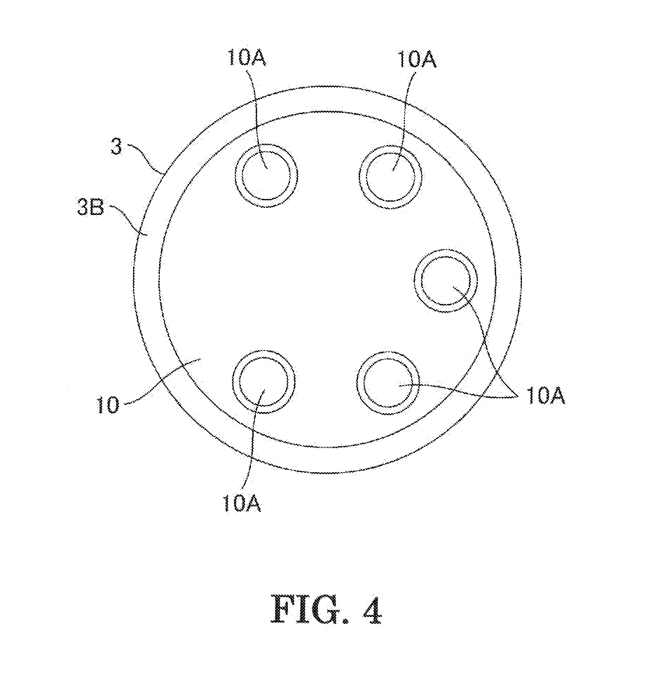

In FIG. 1, the insulating base 7 except for its peripheral portion is bored up to the portion at which the opening 3A is provided. Thus, the space 20 is defined by the peripheral portion of an end of the insulating base 7 and the printed circuit board 10. As illustrated in FIGS. 1 and 4, the folded portion 3B formed on an opening end side of the unit casing 3 presses the rear surface (lower side as viewed in FIG. 1) of the printed circuit board 10. Thus, pressing force towards the inner bottom surface of the unit casing 3 is applied to the elements such as the printed circuit board 10, the insulating base 7, the fixed electrode 6, the spacer (not illustrated), and the diaphragm 11 in this order. Thus, the elements are positioned and fixed in the unit casing 3. With the rear surface of the printed circuit board 10 being pressed, the space 20 defined by the peripheral portion of an end of the insulating base 7 and the printed circuit board 10 is isolated from an external space 21 of the unit casing 3. The peripheral surface of the insulating base 7 in contact with the opening 3A is cutout in a circumferential direction. The space that communicates the portion at which the opening 3A is provided to the printed circuit board 10 is provided. Thus, the shielded wire 14 is inserted through the center hole of the flexible pipe 2 and the opening 3A provided on the peripheral side surface of the unit casing 3 and communicated with the center hole and the three lines of the shielded wire 14 are connected to the certain wiring pattern formed on the front side (upper side as viewed in FIG. 1) of the printed circuit board 10. The insulating base 7 is provided with an acoustic terminal hole 8 communicated with the external of the unit casing 3 from the rear side (lower side as viewed in FIG. 1) of the fixed electrode 6. The acoustic terminal hole 8 is defined to have a cylindrical shape and to extend toward the external of the unit casing 3. The insulating base 7 is provided with recesses 7A that are each provided on the front side (upper side as viewed in FIG. 1) that is connected to the fixed electrode 6 and the rear side (lower side as viewed in FIG. 1) opposite thereto. The recesses 7A, the acoustic terminal hole 8, and the space 20 defined by the peripheral portion of an end of the insulating base 7 and the printed circuit board 10 are communicated with each other.

The printed circuit board 10 is provided with multiple circular holes 10A arranged to surround the center of the printed circuit board 10. The holes 10A and the acoustic terminal hole 8 form the rear acoustic terminal. The number of holes 10A can be arbitrarily set based on the design concept. An FET 9 forming the impedance converter is disposed on the front side (upper side as viewed in FIG. 1) of the printed circuit board 10. The fixed electrode 6 is provided with a contact 4 on the rear surface. A terminal of the FET 9 is in connection with the contact 4 extending from the fixed electrode 6. Thus, the FET 9 and the fixed, electrode 6 are electrically connected with each other.

In the embodiment of the close-talking capacitor microphone described above, the opening is provided on the peripheral side portion of the unit casing 3 at the portion between the front side of the printed circuit board 10 and the rear side of the fixed electrode 6 with regard to the height direction. Furthermore, the space communicating the opening to the front surface of the printed circuit board 10 is provided. The opening 3A and the space 20 that is provided inside the unit casing 3 and communicates the portion at which the opening 3A is provided to the printed circuit board 10 are provided. The shielded wire 14 is inserted through the opening 3A to be connected to the certain wiring pattern formed on the front side of the printed circuit board 10. Thus, the connected portion between the capacitor microphone unit 15 and the shielded wire 14 is not exposed. Therefore, the occurrence of noise due to external electro-magnetic waves is prevented. Furthermore, the shielded wire 14 can be connected to the printed circuit board 10 without being bent at a large angle. Thus, assembly is easy and breakage of the shielded wire 14 can be prevented.

The present invention is not limited to an example of the embodiment of the present invention described above. For example, the structure of the close-talking capacitor microphone according to the present invention can be applied to a helmet to be used as a headset for communication while driving a motorcycle.

What is claimed is:

1. A close-talking capacitor microphone comprising:
a capacitor microphone unit including:
a diaphragm,
a diaphragm holder to which the diaphragm is attached,
a fixed electrode arranged opposite to the diaphragm with a space therebetween and forming a capacitor with the diaphragm,
a printed circuit board on which an impedance converter is disposed,
an insulator provided on the rear side of the fixed electrode, and
a unit casing provided with a sound-wave guidance hole on the front side and the printed circuit board on the rear side;
a microphone casing that fixes the capacitor microphone unit therein and is provided with a sound-wave guidance hole on the front side and the rear side of the unit casing; and
a shielded wire through which a sound signal is communicated, wherein
the unit casing is provided with an opening on a peripheral side surface at a portion between the front side of the printed circuit board and the rear side of the fixed electrode with regard to the height direction,
the unit casing is provided with a space that communicates the opening to the front surface of the printed circuit board, and
the shielded wire is inserted through the opening on the peripheral side surface of the unit casing to be connected to the printed circuit board.

2. The close-talking capacitor microphone according to claim 1, wherein the capacitor microphone unit is a unidirectional capacitor microphone unit provided with a rear acoustic terminal formed of at least one hole in the printed circuit board and the insulator.

3. The close-talking capacitor microphone according to claim 1, wherein the capacitor microphone unit is incorporated in the microphone casing with the central axis direction thereof aligned with that of the microphone casing, and both ends of the microphone casing in the central axis direction are opened.

4. The close-talking capacitor microphone according to claim 3, wherein opened surfaces at both ends of the microphone casing in the central axis direction are covered with respective protecting members.

5. The close-talking capacitor microphone according to claim 1, wherein a flexible pipe is connected to the microphone casing with a center hole of the flexible pipe communicating with a hole penetrating the peripheral wall of the microphone casing, and the shielded wire passes through the holes thus communicated.
